(19) United States
(12) Patent Application Publication
(10) Pub. No.: US 2010/0321503 A1
(43) Pub. Date: Dec. 23, 2010

(54) IMAGE CAPTURING APPARATUS AND IMAGE CAPTURING METHOD

(76) Inventor: Seiichiro SAKATA, Tokyo (JP)

Correspondence Address: STRAUB & POKOTYLO, 788 Shrewsbury Avenue, TINTON FALLS, NJ, 07724, US

(21) Appl. No.: 12/814,285

(22) Filed: Jun. 11, 2010

(30) Foreign Application Priority Data
Jun. 18, 2009 (JP) 2009-145366

(51) Int. Cl. H04N 5/225

(52) U.S. Cl. 348/169; 348/E05.024

(57) ABSTRACT

There is provided an image capturing apparatus and method capable of preventing frame-out of a moving object even when a fast-moving object is photographed. The solution comprises: an image capturing unit that obtains image data by capturing an object; a moving object detecting unit that detects a moving object to be tracked based on the image data obtained with the image capturing unit; a tracking frame setting unit that sets an area portion which includes the moving object in the image data as a tracking frame when the moving object is detected by the moving object detecting unit; a display frame setting unit that sets an area which is shifted from the tracking frame in the image data in the direction opposite to the moving direction of the moving object as a display frame; and a display processing unit that displays the image data which is included in the display frame on a display unit.

### FIELD OF THE INVENTION

The present invention relates to an image capturing apparatus and an image capturing method.

### BACKGROUND OF THE INVENTION

There is known an image capturing apparatus which has a framing assisting function to assist framing, that is, determination of frame position and size when photographing an object (see JP2007-267177A).

In JP2007-267177A, there is disclosed a technology, wherein by utilizing the random accessibility of an imaging sensor, a full-shot video image and an up-shot video image of an imaging sensor unit are alternately switched by alternately reading out the full-shot image where the imaging device is sub-sampled and read out and an up-shot video image where only a part of the imaging device is read out.

According to the technology disclosed in JP2007-267177A, the up-shot video image is recorded while the full-shot video image is being displayed. Therefore, even when the resolution of imaging device becomes super-high resolution in the future, both the photographable area and surrounding situation can be displayed on a finder, so that a framing assist to take account of composition including the surroundings can be realized without lowering the resolution.

### SUMMARY OF THE INVENTION

An image capturing apparatus according to an embodiment of the present invention is characterized by comprising: an image capturing unit that obtains image data by capturing an object; a moving object detecting unit that detects a moving object to be tracked based on the image data obtained with the image capturing unit; a tracking frame setting unit that sets an area portion including the moving object in the image data as a tracking frame when the moving object is detected by the moving object detecting unit; a display frame setting unit that sets an area which is shifted from the tracking frame in the image data in the direction opposite to the moving direction of the moving object as a display frame; and a display processing unit that displays the image data which is included in the display frame on a display unit.

An image capturing method according to another embodiment of the present invention is an image capturing method for an imaging capturing apparatus comprising an image capturing unit for obtaining image data by capturing an object and a display unit for displaying an image data and is characterized by comprising: a moving object detecting process for detecting a moving object to be tracked based on the image data obtained with the image capturing unit; a tracking frame setting process for setting an area portion which includes the moving object in the image data as a tracking frame when the moving object is detected by the moving object detecting process; a display frame setting process for setting an area which is shifted from the tracking frame in the image data in the direction opposite to the moving direction of the moving object as a display frame; and a display processing procedure for displaying the image data which is included in the display frame on a display unit.

### BRIEF DESCRIPTION OF THE DRAWINGS

FIG. 1 is a perspective view of the front face side of the digital camera according to the embodiment of the present invention.

FIG. 2 is a perspective view of the back face side of the digital camera according to the embodiment of the present invention.

FIG. 3 is a diagram showing a hardware structure example of the digital camera according to the embodiment of the present invention.

FIG. 4 is a flowchart showing control logic of the digital camera according to the embodiment of the present invention.

FIG. 5 is a chart describing step S1 in FIG. 4.

FIG. 6 is a figure showing an example of changes with time of image data, display frame and store frame during control logic execution.

FIGS. 7A, 7B and 7C are charts showing an example of changes with time of offset amount Ox, Dx and Rx respectively during control logic execution.

FIG. 8 is a figure showing another example of changes with time of image data, display frame and store frame during control logic execution.

FIG. 9 is a figure describing an effect of a digital camera according to the embodiment of the present invention.

FIG. 10 is a figure describing notification of warning of frame-out.

### DESCRIPTION OF THE PREFERRED EMBODIMENT

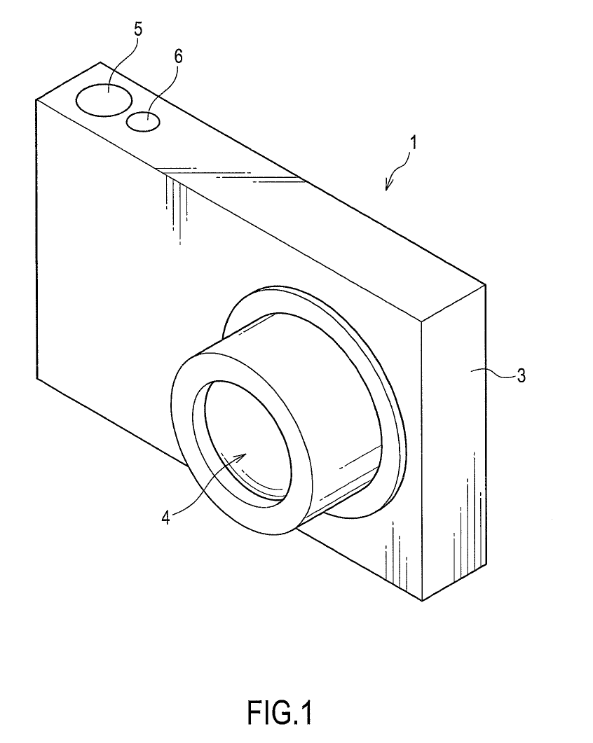

Referring to the accompanying drawings, the embodiment of the present invention will be described below. The present invention will be described below taking a case when the present invention is applied to a digital camera capable of video recording as an example (see FIG. 1).

(Structure of Apparatus)

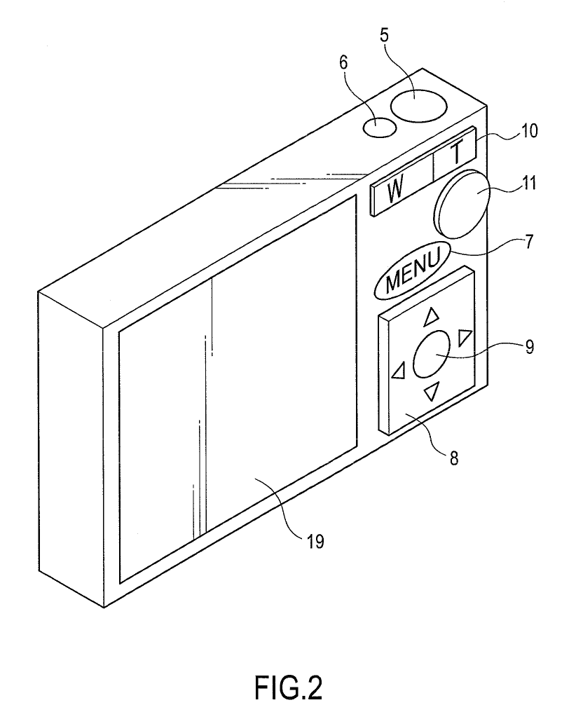

FIG. 1 is a perspective view of the front face side of the digital camera 1 according to the embodiment of the present invention. FIG. 2 is a perspective view of the back face side of the digital camera 1 according to the embodiment of the present invention.

As shown in FIG. 1 and FIG. 2, the digital camera 1 according to the embodiment of the present invention has a common device structure comprising a camera body 3 formed in nearly rectangular shape, a lens 4 as an optical system, a shutter button 5 as an operation unit, a power button 6 (see FIG. 1), a menu button 7, an arrow key 8, an OK/FUNC button 9, a zoom button 10, a mode dial 11, and a display unit 19 such as an LCD monitor (see FIG. 2).

In the following, the shutter button 5 through the mode dial 11 are described.

The shutter button 5 is an operation button for instructing recording moving images (contiguous still images) to be captured with the lens 4. The power button 6 is an operation button for turning on or off the power supply of this digital camera 1. The menu button 7 is an operation button for displaying a menu screen for settings of this digital camera 1 on the display unit 19. The arrow key 8 is an operation button for selecting a desired menu item by, for example, moving a cursor position in the menu screen displayed on the display unit 19. The OK/FUNC button 9 is an operation button for deciding a menu item selected by the arrow key 8 as a selected item. The zoom button 10 is an operation button for instructing changing focal length by moving the lens 4 toward wide side or tele side. The mode dial 11 is an operation button for setting operation mode of the digital camera 1 such as video recording mode or still image recording mode.

(Hardware Structure)

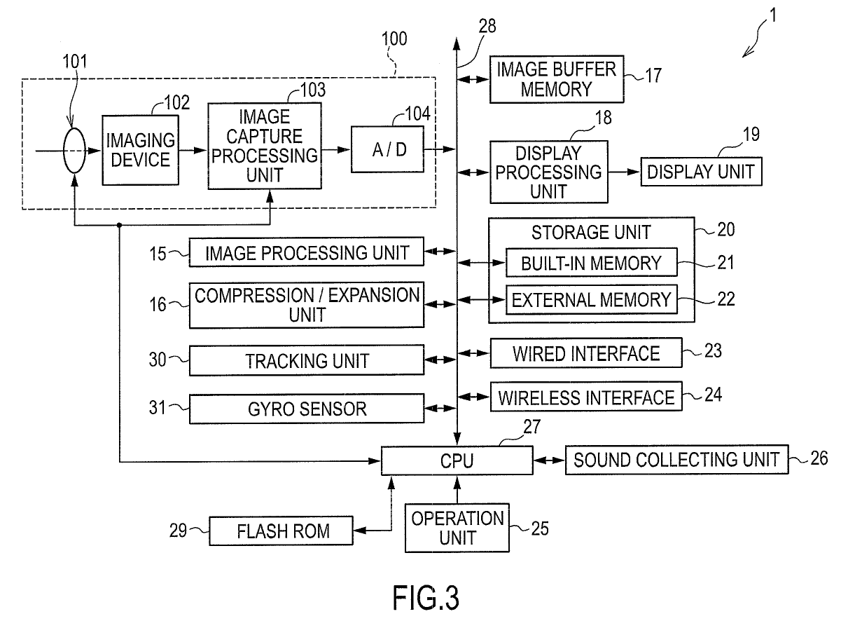

FIG. 3 is a diagram showing a hardware structure example of the digital camera 1 according to the embodiment of the present invention. The digital camera 1 shown in FIG. 3 comprises a lens 101 (corresponding to the lens 4 in FIG. 1), an imaging device 102, an image capture processing unit 103, an A/D 104 (the lens 101 to the A/D 104 will be called as an “image capturing unit 100”), an image processing unit 15, a compression/expansion unit 16, an image buffer memory 17, a display processing unit 18, a display unit 19 (corresponding to the display unit 19 in FIG. 2), a storage unit 20, a built-in memory 21, an external memory 22, a wired interface 23, a wireless interface 24, an operation unit 25, a sound collecting unit 26, a CPU 27, a bus 28, a flash ROM 29, a tracking unit 30, a gyro sensor 31 and so on.

Constituent components will be described below in random order.

The image capturing unit 100 captures an object and sequentially obtains image data (image signals). The obtained image data is output to the image buffer memory 17 via the bus 28. This image capturing unit 100 comprises the lens 101, the imaging device 102, the image capture processing unit 103 and the A/D 104.

The lens 101 forms an image of an object on the imaging device 102. The imaging device 102 outputs analog electric signals representing the image obtained by performing photoelectric conversion of the object image formed with the lens 101, to the image capture processing unit 103. This imaging device 102 is, for example, a CCD (Charge Coupled Device). The image capture processing unit 103 reduces noise component of the analog electric signals which are output from the imaging device 102, stabilizes the signal levels and outputs the analog electric signals to the A/D 104. The image capture processing unit 103 comprises circuits such as a CDS (Correlated Double Sampling) for reducing the noise component of the analog electric signals and an AGC (Automatic Gain Control) for stabilizing the signal levels. The A/D 104 converts the analog electric signals which are output from the image capture processing unit 103 to digital electric signals. After being converted, the digital electric signals are output to the bus 28 as image data.

The image buffer memory 17 stores the image data temporarily which is output from the A/D 104 to the bus 28. This image buffer memory 17 is a memory device such as, for example, a DRAM (Dynamic Random Access Memory).

The image processing unit 15 performs correction processing such as gamma correction and white balance correction and image processing such as enlargement/reduction processing for enlarging/reducing pixels (resize processing) for the image data stored in the image buffer memory 17, the built-in memory 21 or the external memory 22. This image processing unit 15 performs the image processing above as preprocessing when the image data is to be displayed on the display unit 19 based on the image data stored in the image buffer memory 17, the built-in memory 21 or the external memory 22 and when the image data stored in the image buffer memory 17 is to be stored in the built-in memory 21 or the external memory 22.

The compression/expansion unit 16 carries out a compression processing when the image data image-processed by the image processing unit 15 is to be stored in the built-in memory 21 or the external memory 22, and carries out an expansion processing when the image data stored in the built-in memory 21 or the external memory 22 is to be read. The compression processing and expansion processing as described here are processes based on such as the JPEG (Joint Photographic Experts Group) method and MPEG (Moving Picture Experts Group) method.

The display processing unit 18 generates video signals which can be displayed on the display unit 19 and outputs them to the display unit 19 when the image data is to be displayed on the display unit 19 based on the image data image-processed by the image processing unit 15. The display unit 19 displays video according to the video signals which are output by the display processing unit 18. This display unit 19 is a display device such as, for example, a liquid-crystal display.

The storage unit 20 stores image data. Here, the image data is what has been already image-processed by the image processing unit 15 and compression-processed by the compression/expansion unit 16. This storage unit 20 comprises the built-in memory 21 and the external memory 22. The built-in memory 21 is a memory which has been previously embedded in the digital camera 1. The external memory 22 is a detachable memory card such as, for example, xD-Picture Card (registered trademark).

The wired interface 23 is an interface for connecting the digital camera 1 and an external device in accordance with a wired communication standard. An example of wired communication standard is USB (Universal Serial Bus). The wireless interface 24 is an interface for connecting the digital camera 1 and an external device in accordance with a wireless communication standard. An example of wireless communication standard is IrDA (Infrared Data Association).

An operation unit 25 comprises the shutter button 5, the Power button 6, the menu button 7, the arrow key 8, the OK/FUNC button 9, the zoom button 10, the mode dial 11 and so on shown in FIG. 1. Operating information related to the operation unit 25 is sent to the CPU 27. The sound collecting unit 26 is a device like a microphone for collecting sounds. Sound signals obtained by the sound collecting unit 26 are sent to the CPU 27.

The CPU 27 controls the whole operation of the digital camera 1 by reading out a control program stored in the flash ROM 29 to execute the control program.

After receiving instruction from the CPU 27, the tracking unit 30 detects the presence or absence of a moving object to be tracked in the object (for example, a running person) based on the image data stored in the image buffer memory 17. When the moving object is detected, this moving object is tracked, and then information related to the moving object such as size, location and moving direction are detected and sent to the CPU 27.

The gyro sensor 31 is a sensor for detecting movements of the camera body 3 such as camera shake. It detects information related to camera shake such as shake amount and sends the information to the CPU 27.

With the hardware structure above, in the digital camera 1 according to the embodiment of the present invention, after receiving instruction information of video recording from the operation unit 25 (shutter button 5), the CPU 27 makes the tracking unit 30 detect the moving object and track the moving object. Furthermore, frame-out of the moving object can be prevented by controlling operation of the display processing unit 18 and the storage unit 20 according to tracking results by the tracking unit 30. Details will be described later.

(Control Logic of the Digital Camera 1)

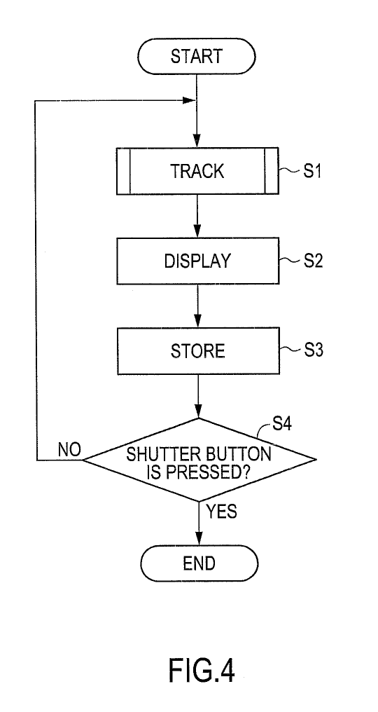

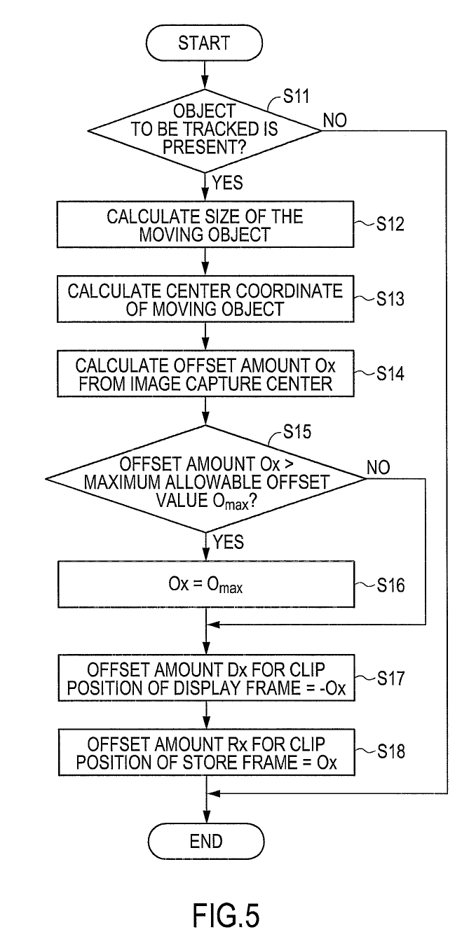

FIG. 4 is a flowchart showing control logic of the digital camera according to the embodiment of the present invention. FIG. 5 is a chart describing step S1 in FIG. 4. Control logic shown in FIG. 4 is started when the shutter button 5 is pressed in video recording mode on the digital camera according to the embodiment of the present invention. Process at each step will be described below in relation to each constituent component in FIG. 3.

First, tracking is conducted at step S1. Here, the tracking unit 30 tracks a moving object in an object. Specifics will be described using FIG. 5.

At step S11 in FIG. 5, the tracking unit 30 detects whether or not an object to be tracked is present (S11). Here, the tracking unit 30 detects whether a moving object (for example, a running person) to be tracked is present based on image data stored in the image buffer memory 17, that is, based on photographed image data. This detection is realized using known technology. When the moving object to be tracked is detected (S11 YES), the process proceeds to step S12. When the moving object to be tracked is not detected (S11 NO), the process shown in FIG. 5 is terminated.

When the process proceeds to step S12, the tracking unit 30 calculates size of the moving object (S12). Here, the size of the moving object detected at step S11 is calculated. Further, an area portion which includes this moving object in the photographed image is set as a tracking frame according to the calculated size of the moving object.

Subsequently, the process proceeds to step S13, where the tracking unit 30 calculates the center coordinate of the moving object (S13). Here, the center coordinate of the moving object detected at step S11 is calculated. This center coordinate of the moving object shall be same as that of the tracking frame.

Subsequently, the process proceeds to step S14, where the tracking unit 30 calculates an offset amount Ox from the image capture center (S14). Here, the distance from the image capture center of the image data to the center coordinate of the moving object which is calculated at step S13 is calculated as an offset amount Ox. This is done in order to detect that the moving object is close to/far from the center of the image data. The larger this offset amount Ox is, the farther the moving object is from the center of the image data, which means the frame-out probability is high. On the other hand, the smaller this offset amount Ox is, the closer the moving object is to the center of the image data, which means the frame-out probability is low.

Subsequently, the process proceeds to step S15, where the tracking unit 30 detects whether the offset amount Ox is beyond the maximum allowable offset value Omax (S15). The maximum allowable offset value O max is the distance to which a frame such as tracking frame can be offset in a direction from the image capture center of the image data toward the edge of the image. When the offset amount is larger than this maximum allowable offset value Omax, this means that the moving object has moved out of the frame.

In the case of YES at step S15 (S15 YES), the process proceeds to step S16. The tracking unit 309 sets the maximum allowable offset value Omax to the offset amount Ox (S16), and the process proceeds to step S17. In the case of NO at step S15 (S15 NO), the process proceeds to step S17.

When the process proceeds to step S17, the tracking unit 30 sets −Ox as the offset amount Dx for clip position of a display frame (S17). The display frame is an area portion to be displayed on the display unit 19 in the image data stored in the image buffer memory 17. In order to clip such a display frame from the image data the clip position is offset from the center coordinate of the moving object by −Ox (opposite of the offset amount Ox). In other words, the clip position of the display frame is offset by Ox in the direction opposite to the moving direction of the moving object. This is for intentionally displaying the moving object at an edge of the image on the display unit 19.

Subsequently, the process proceeds to step S18. The tracking unit 30 sets Ox as the offset amount Rx for clip position of the store frame (S18). The store frame is an area portion to be stored in the storage unit 20 within the image data stored in the image buffer memory 17. In order to clip such a store frame from the image data the clip position is offset from the image capture center by Ox. In other words, the clip position of the store frame is offset by Ox in the same direction as the moving direction of the moving object. This is for storing image data which includes the moving object in the storage unit 20.

Returning to FIG. 4, the process proceeds to step S2 and display is conducted (S2). Here, the display processing unit 18 clips the display frame from the image data according to the offset amount Dx set at step S17 and displays the image data contained in this clipped display frame on the display unit 19.

Subsequently, the process proceeds to step S3 and storing is conducted (S3). Here, the storage unit 20 clips the store frame from the image data according to the offset amount Rx set at step S18 and stores the image data contained in this clipped store frame in the built-in memory 21 or in the external memory 22.

Subsequently, the process proceeds to step S4 and it is determined whether or not the shutter button 5 is pressed (S4). Here, the CPU 27 determines whether the shutter button 5 is pressed based on information obtained from the operation unit 25. When the shutter button 5 is pressed (S4 YES), it is determined that video recording is finished and then the process is terminated. When the shutter button 5 is not pressed (S4 NO), the process returns to step Si and the process is repeated.

The control logic shown in FIG. 4 and FIG. 5 is started using the process shown above when the shutter button 5 is pressed in the video recording mode on the digital camera according to the embodiment of the present invention. The series of the processes are repeated sequentially until the shutter button 5 is pressed again. A user can switch whether to enable or disable the function of such a control logic as shown in FIG. 4 and FIG. 5 by operating the operation unit 25. A specific example for the control logic will be described below.

(A Specific Example for the Control Logic Execution)

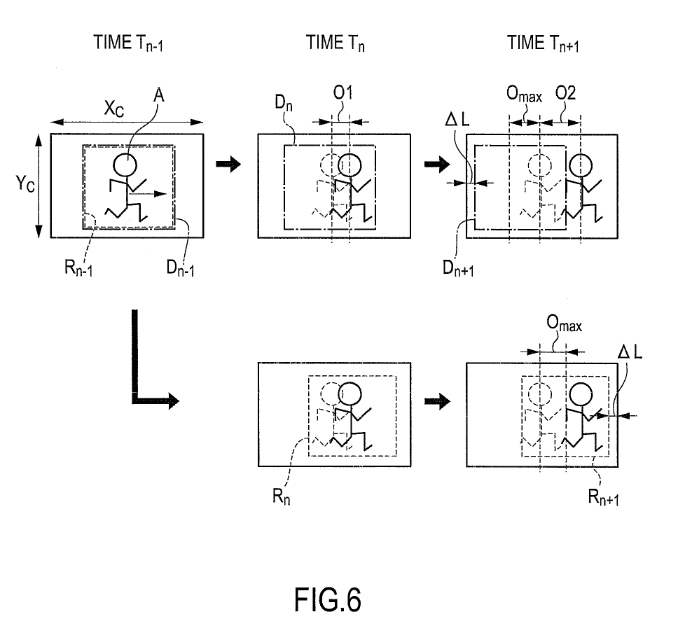

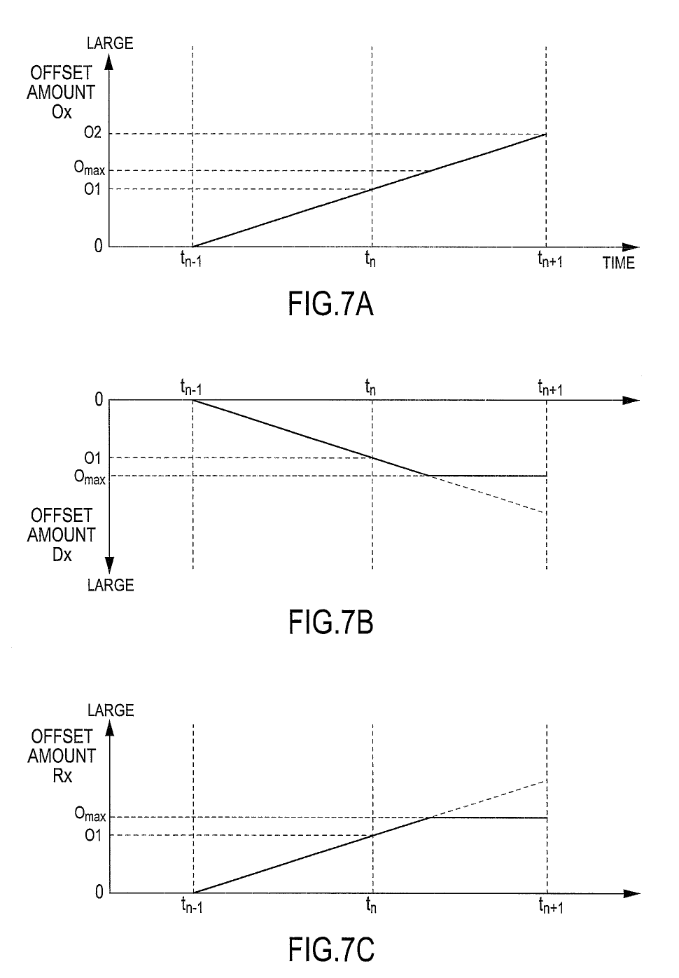

FIG. 6 is a figure showing an example of changes with time of the image data, the display frame and the store frame during control logic execution. FIGS. 7A-7C are charts showing an example of changes with time of each offset amount of Ox, Dx and Rx during control logic execution.

In this specific example, a case when the control logic shown in FIG. 4 and FIG. 5 is executed at time Tn−1, Tn and Tn+1 respectively will be described as an example. Description will be made below corresponding to flowcharts of FIG. 4 and FIG. 5.

At time Tn−1, as shown in FIG. 6, a moving object A is generally at the center of image data (solid outer frame of width Xc and height Yc) (S11 YES). The offset amount Ox is nearly zero at this time (see S14 and FIG. 7A). Then, the offset amount DX and offset amount RX are set to roughly zero (see S17, S18, FIG. 7B and FIG. 7C). As a result, as shown in FIG. 6 (a), each of the display frame Dn−1 and the store frame Rn−1 is represented by an area which includes the moving object. A generally at the center.

In this case, the moving object A is displayed generally at the center of the display unit 19. Also, the image data where this moving object is generally at the center is stored in storage unit 20.

At time Tn, as shown in FIG. 6, the moving object A has moved from the center of the image data (solid outer frame) in the right direction by O1 (S11 YES). The offset amount Ox is O1 at this time (see S14 and FIG. 7A). Then, the offset amount Dx is set to −O1 and the offset amount Rx is set to O1 respectively (see S17, S18, FIG. 7B and FIG. 7C). As a result, as shown in FIG. 6, the display frame Dn is represented by an area shifted by O1 in the direction opposite to the moving direction of the moving object A from the center coordinate of the moving object A. On the other hand, as shown in FIG. 6, the store frame Rn is represented by an area shifted by O1 in the same direction as the moving direction of the moving object A from the image capture center.

In this case, the moving object A is displayed close to the edge of the display unit 19. Meanwhile, the image data with the moving object A at the center is stored in storage unit 20 in the same manner as at time Tn−1.

At time Tn+1, as shown in FIG. 6, the moving object A has moved from the center of the image data (solid outer frame) by O2 (S11 YES). The offset amount Ox is O2 at this time (see S14 and FIG. 7A). The offset amount Ox is set to the maximum allowable offset value Omax because this offset amount O2 is larger than the maximum allowable offset value Omax (S15 YES, S16). Here, the maximum allowable offset value O max is the distance in which the camera shake amount ΔL detected by the gyro sensor 31 is deducted from an offsettable distance of the tracking frame in a direction from the center of the image data toward the edge of the image. Then, the offset amount Dx is set to −Omax and the offset amount Rx is set to Omax respectively (see S17, S18, FIG. 7B and FIG. 7C). As a result, as shown in FIG. 6, the display frame Dn+1 is represented by an area shifted by Omax in the direction opposite to the moving direction of the moving object A from the center coordinate of the moving object A. On the other hand, as shown in FIG. 6, the store frame Rn+1 is represented by an area shifted by Omax in the same direction as the moving direction of the moving object A from image capture center.

In this case, the moving object A is not displayed on the display unit 19 because the moving object A has moved out of the display frame Dn+1. However, the image data which includes the moving object. A is stored in the storage unit 20 in the same manner as at times Tn and Tn−1.

A set of the control logic executions at time Tn−1, Tn and Tn+1 shown in FIG. 4 and FIG. 5 has been described above. As can be seen from FIG. 6, although the moving object A has moved out of the display frame Dn+1 at time Tn+1 in particular, (and at time Tn, the moving object A possibly moves out of the display frame Dn), the store frame Rn+1 (and the store frame Rn) includes the moving object A.

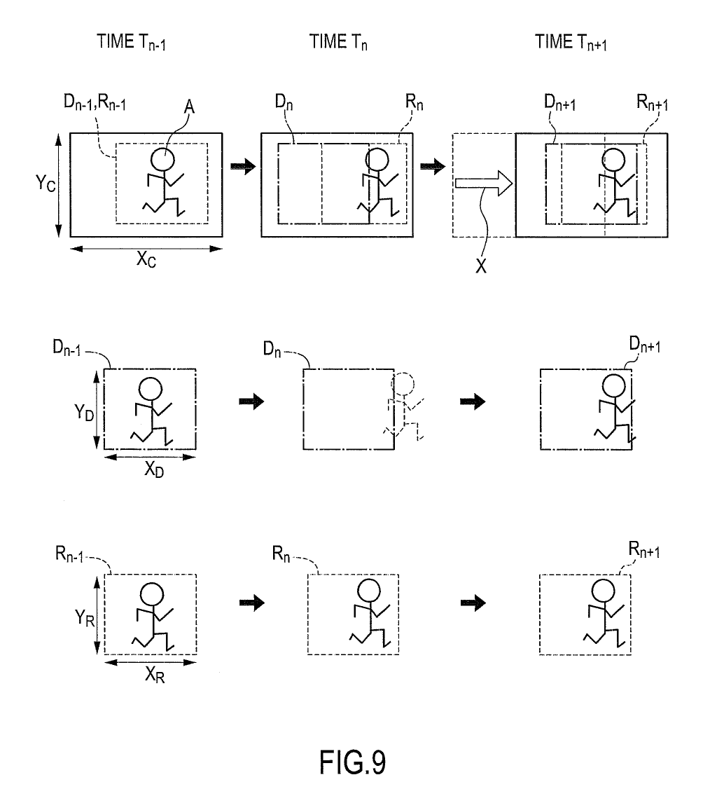

By employing the control logic according to the embodiment of the present invention, the condition in which the moving object A is stored in the storage unit 20 can be maintained while intentionally displaying the moving object. A at the edge of the image on the display unit 19 as shown in FIG. 6. Effects of the operation will be described later using FIG. 9.

(Another Specific Example of the Control Logic Execution)

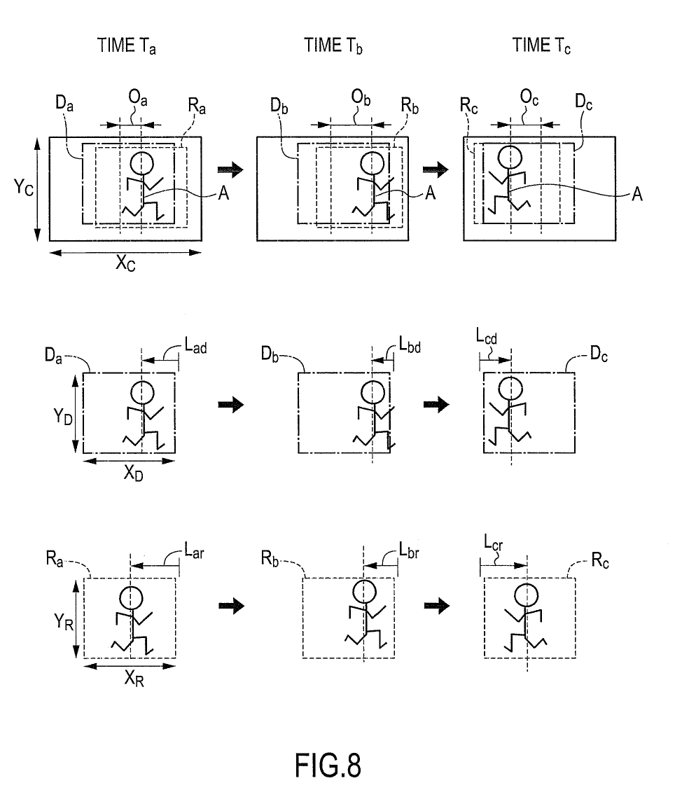

FIG. 8 is a figure showing another example of changes with time of image data, display frame and store frame during the control logic execution. In this specific example, a case when the control logic shown in FIG. 4 and FIG. 5 is executed at time Ta, Tb and Tc respectively will be described. Description will be made below in correspondence with the flowcharts of FIG. 4 and FIG. 5.

At time Ta, as shown in FIG. 8, a moving object A has moved from approximately the center of image data (solid outer frame of width Xc and length Yc) in the right direction by Oa (S11 YES). The offset amount Ox is Oa (<Omax) at this time (S14). Then, the offset amount Dx is set to −Oa and the offset amount Rx is set to Oa respectively (S17, S18). As a result, as shown in FIG. 8, the display frame Dn is represented by an area shifted by Oa in the direction opposite to the moving direction of the moving object. A from the center coordinate of the moving object A. Meanwhile, the store frame Ra is represented by an area shifted by Oa in the same direction as the moving direction of the moving object A from the image capture center.

As shown in FIG. 8, the moving object A is placed away from the edge of the image by Lad in the display frame Da (dashed-dotted frame of width Xd and height Yd). Meanwhile, as shown in FIG. 8, in the store frame Ra (dotted frame of width Xr and height Yr), the moving object A is closer to the center of the frame, away from the edge of the image by Lar which is larger than Lad.

At time Tb, as shown in FIG. 8, the moving object A has moved from the center of the image data (solid outer frame) by Ob (>Omax) (S11 YES). The offset amount Ox is Ob at this time (S14). The offset amount Ox is set to the maximum allowable offset value Omax because this offset amount Ob is larger than the maximum allowable offset value Omax (S15 YES, S16). Then, the offset amount Dx is set to −Omax and the offset amount Rx is set to Omax respectively (S17, S18). As a result, as shown in FIG. 8, the display frame Db is represented by an area shifted by Omax in the direction opposite to the moving direction of the moving object A from the center coordinate of the moving object. A. Meanwhile, the store frame Rb is represented by an area shifted by Omax in the same direction as the moving direction of the moving object A from the image capture center.

Also in this case, as shown in FIG. 8, the moving object A is placed away from the edge of the image by Lbd in the display frame Db. Meanwhile, as shown in FIG. 8, in the store frame Rb, the moving object A is closer to the center of the frame, away from the edge of the image by Lbr which is larger than Lbd.

At time Tc, as shown in FIG. 8, the moving object A has moved from the center of the image data (solid outer frame) in the left direction by Oc (<Omax) (S11 YES). The offset amount Ox is Oc at this time (S14). Then, the offset amount. Dx is set to −Oc and the offset amount Rx is set to Oc respectively (S17, S18). As a result, as shown in FIG. 8, the display frame Dc is represented by an area shifted by Oc in the direction opposite to the moving direction of the moving object A from the center coordinate of the moving object A. Meanwhile, the store frame Rc is represented by an area shifted by Oc in the same direction as the moving direction of the moving object A from the image capture center.

Also in this case, as shown in FIG. 8, the moving object A is placed away from the edge of the image by Lcd in the display frame Dc. Meanwhile, as shown in FIG. 8, in the store frame Rc, the moving object A is closer to the center of the frame, away from the edge of the image by Lcr larger than Lcd.

A set of the control logic execution shown in FIG. 4 and FIG. 5 at times Ta, Tb and Tc respectively has been described above. As can be seen from FIG. 8, the moving object. A is closer to the center in the store frame Ra, Rb or Rc respectively than the moving object A in the display frame Da, Db or Dc respectively in each case.

Therefore, in the same manner as for the previously described specific example, by employing the control logic according to the embodiment of the present invention, the condition in which the moving object A is stored in the storage unit 20 can be maintained while intentionally displaying the moving object. A at an edge of the image on the display unit 19 as shown in FIG. 8. Effects of the operation will be described later using FIG. 9.

(Effects by a Digital Camera 1 According to the Embodiment of the Present Invention)

FIG. 9 is a figure describing an effect of a digital camera according to the embodiment of the present invention. Referring to FIG. 9, the effects provided by the described operation will be described here.

At time Tn−1, as shown in FIG. 9, the display frame Dn−1 and the store frame Rn−1 are represented by an area which includes the moving object A at approximately the center. As a result, the moving object A is displayed at the center of the display unit 19. Meanwhile, the image data which includes this moving object A approximately at the center of the image data is stored in storage unit 20.

At time Tn, as shown in FIG. 9, the moving object A in display frame Dn is displayed close to the edge. Even in this case, the condition where the image data is stored in the storage unit 20 can be maintained because the store frame Rn includes the moving object A as shown in FIG. 9.

Thus, the possibility of frame-out of the moving object A is made perceptible in advance to the photographer of the digital camera 1 using display style shown in FIG. 9 before the moving object A goes out of the frame. Additionally, it is made perceptible to the photographer that he should move (pan) the digital camera 1 to the same direction as the moving direction of the moving object A.

When the photographer who has recognized such a displaying moves the digital camera 1 to the same direction as the moving direction of the moving object. A (the photographer does pan X in FIG. 9), at subsequent time Tn+1, as shown in FIG. 9, the display frame Dn−1 and the store frame Rn−1 respectively are represented by an area which includes the moving object A. As a result, the moving object A is displayed on the display unit 19. Meanwhile, the image data which includes this moving object A is continuously stored in the storage unit 20.

Thus, with the digital camera 1 according to the embodiment of the present invention the condition in which the moving object A is stored in the storage unit 20 is maintained while intentionally displaying the moving object A at an edge of the image on the display unit 19 as shown in FIG. 9. As a result, the possibility of frame-out is made perceptible in advance to the photographer of the digital camera 1 even when photographing a fast-moving object. In this way, the frame-out of moving object can be avoided, and the moving object can be captured appropriately.

(Notification of Warning of Frame-Out)

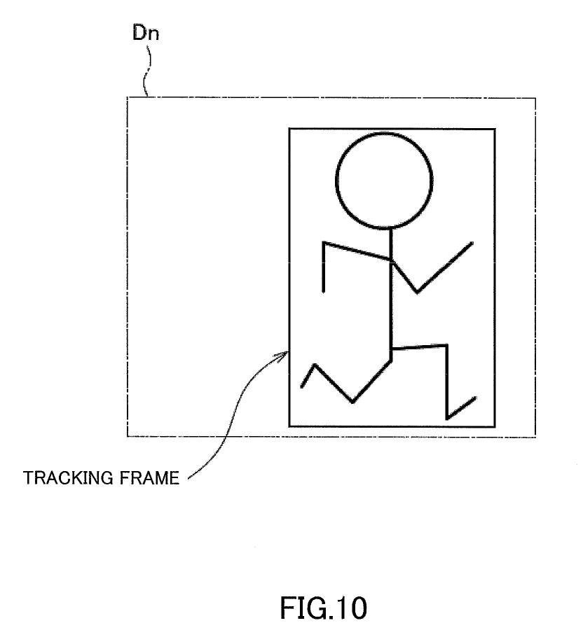

FIG. 10 describes notification of warning of frame-out. In the previously mentioned FIG. 9, the possibility of frame-out is made perceptible to the photographer of the digital camera 1 in advance by displaying the moving object A close to the edge in the display frame Dn.

In place of this, as shown in FIG. 10, the possibility of frame-out of the moving object can be notified by changing the color of the tracking frame to, for example, red when the tracking frame of the moving object A approaches the edge of the display frame Dn. The display processing unit 18 realizes such a display process at step S2 in FIG. 4. In this way, the method of notifying the warning of frame-out as shown in FIG. 10 can also prevent the frame-out of the moving object, and the moving object can be photographed appropriately.

(Summary)

As described above, according to the embodiment of the present invention, the area shifted from the tracking frame in the image data in the direction opposite to the moving direction of the moving object is set as the display frame. As a result, the possibility of frame-out is made perceptible in advance to the photographer even when photographing a fast-moving object. In this way, the frame-out of moving object can be avoided.

Additionally, according to the embodiment of the present invention, even when the display frame is set as above described, an area portion which includes the moving object in the image data is set as the store frame. In this way, the frame-out of moving object can be avoided, and the moving object can be captured appropriately.

Additionally, according to the embodiment of the present invention, the possibility of frame-out of the moving object is notified when the tracking frame approaches the edge of the display frame. As a result, the possibility of frame-out is made perceptible in advance to the photographer of the digital camera 1 even when photographing a fast-moving object. In this way, the frame-out of moving object can be avoided effectively.

Additionally, according to the embodiment of the present invention, the user is prompted to switch whether to enable or disable the function of such a control logic as shown in FIG. 4 and FIG. 5. As a result, the user can switch to a mode for preventing the frame-out of moving object.

Now in the above-described embodiment, a hardware based process is assumed for the process of the image-taking apparatus, but the present invention is not limited to such a structure. For example, a structure is possible where separate software performs the process. In this case, the image-taking apparatus comprises the CPU, a main memory unit such as a RAM and a computer-readable medium where a program to perform all or a portion of the process above is stored. Here, this program is called an image capturing program. The same processing of the above mentioned image-taking apparatus is realized through the CPU reading out the image capturing program stored in the medium and executing information processing and calculations.

Here, the computer-readable medium is, for example, a magnetic disk, a magnetic optical disk, CD-ROM, DVD-ROM and a semiconductor memory. The image capturing program can be delivered to a computer via communication line such that the computer which has received this delivery can execute the image capturing program.

The present invention is not limited to the above-described embodiments, and various modifications and applications are possible within the scope of this invention.

For example, according to the description above, the gyro sensor 31 detects information related to camera shake of the camera body 3, but the present invention is not limited to this case. The information related to camera shake may be detected by performing certain image processing of image data captured by the image capturing unit 100.

Additionally, for example, according to the description in FIG. 6 to FIG. 9, the case when the moving object A moves in horizontal direction is described as an example, but the present invention is not limited to this case. The moving object A may move in vertical direction.

Additionally, for example, according to the description above, the case when the digital camera 1 photographs moving images is described as an example, but the present invention is not limited to this case. The digital camera 1 may photograph still images.

Additionally, for example, according to the description of step S17 and step S18 in FIG. 5, for example, the case when the offset amount Dx is set to −Ox and the offset amount Rx is set to Ox respectively is described as an example, but the present invention is not limited to this case. There can be appropriate design variations when setting the offset amount Dx and the offset amount Rx, for example, applying a lowpass or a gain according to values of the offset amount Ox, having an insensible zone, and exponential/logarithmic conversion. That is, the relation between the offset amount Dx (or the offset amount Rx) and the offset amount Ox may be nonlinear, besides the linear one as shown in FIGS. 7B and 7C.

This application claims priority based on JP2009-145366, filed with the Japan Patent Office on Jun. 18, 2009, the entire contents of which are incorporated into this specification by reference.

What is claimed is:

1. An image capturing apparatus comprising:
an image capturing unit that obtains image data by capturing an object;
a moving object detecting unit that detects a moving object to be tracked based on the image data obtained with the image capturing unit;
a tracking frame setting unit that sets an area portion including the moving object in the image data as a tracking frame when the moving object is detected by the moving object detecting unit;
a display frame setting unit that sets an area which is shifted from the tracking frame in the image data in a direction opposite to moving direction of the moving object as a display frame; and
a display processing unit that displays image data in the display frame on a display unit.

2. An image capturing apparatus as defined in claim 1 further comprising:
a store frame setting unit that sets an area portion including the moving object in the image data as a store frame; and
a storing unit that stores image data in the store frame.

3. An image capturing apparatus as defined in claim 1 further comprising:
a notifying unit that notifies a frame-out possibility of the moving object when the tracking frame approaches an edge of the display frame.

4. An image capturing apparatus as defined in claim 1 further comprising:
a switching unit that prompts a user to switch whether to enable or disable the display frame setting unit.

5. An image capturing method for an imaging capturing apparatus comprising an image capturing device for obtaining image data by capturing an object and a display for displaying image data comprising:
a moving object detecting step for detecting a moving object to be tracked based on the image data obtained with the image capturing device;
a tracking frame setting step of setting an area portion including the moving object in the image data as a tracking frame;
a display frame setting step of setting an area which is shifted from the tracking frame in the image data in a direction opposite to moving direction of the moving object as a display frame; and
a display step of displaying image data in the display frame on the display.

6. An image capturing method comprising:
capturing an object and obtaining image data of the object;
detecting a moving object to be tracked in the image data;
setting an area portion including the moving object in the image data as a tracking frame;
setting an area which is shifted from the tracking frame in the image data in a direction opposite to moving direction of the moving object as a display frame; and
displaying image data in the display frame on a display.

7. The image capturing method of claim 6, wherein:
setting an area portion including the moving object in the image data as a store frame; and
storing image data in the store frame into a memory.

8. The image capturing method as defined in claim 7, wherein:
notifying to a user a frame-out possibility of the moving object when the tracking frame approaches an edge of the display frame.

9. The image capturing method as defined in claim 6, further comprising:
determining an offset value between the tracking frame with respect to the image data;
calculating a maximum offset value for the tracking frame; and
comparing the offset value and the maximum offset value.

10. The image capturing method as defined in claim 9, wherein:
the maximum offset value is given by a maximally allowed offset of the tracking frame with respect to the image data minus a value indicative of camera shake.
